(19) United States
(12) Patent Application Publication
(10) Pub. No.: US 2018/0183905 A1
(43) Pub. Date: Jun. 28, 2018

(54) WIRELESS COMMUNICATION DEVICE, SYSTEM AND METHOD TO MULTIPLEX A LOW-POWER WAKE-UP FIRST SIGNAL WITH AN OFDMA SIGNAL

(71) Applicant: Intel Corporation, Santa Clara, CA (US)

(72) Inventors: Shahrnaz Azizi, Cupertino, CA (US); Juan Fang, Portland, OR (US); Minyoung Park, Portland, OR (US); Thomas J. Kenney, Portland, OR (US)

(73) Assignee: Intel Corporation, Santa Clara, CA (US)

(21) Appl. No.: 15/390,623

(22) Filed: Dec. 26, 2016

(51) Int. Cl. H04L 29/06; H04L 5/00; H04W 40/00

(52) U.S. Cl. CPC H04L 69/22; H04L 27/2601; H04W 40/005; H04L 5/0053

(57) ABSTRACT

A wireless communication device, system and method. The device comprises a memory and processing circuitry coupled to the memory. The processing circuitry has logic to multiplex a first signal into a second signal, and to encode the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and cause transmission of a multiplexed signal including the second signal and the first signal multiplexed into the second signal.

### TECHNICAL FIELD

Embodiments relate to wireless communication in a low power setting. Some demonstrative embodiments relate to a construction of low-power wake-up (LP-WU) packet for waking up a wireless local-area network (WLAN) device with low-power wake-up receiver (LP-WUR) within an IEEE 802.11ax network.

### BACKGROUND

Low power wireless devices are enabling many wireless devices to be deployed in wireless local-area network (WLAN). However, the low power wireless devices are bandwidth constrained and power constrained, and yet need to communicate with central devices to download and upload data. Additionally, wireless devices may need to operate with both newer protocols and with legacy station protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some demonstrative embodiments;

FIG. 2 illustrates a radio architecture of a STA or an AP from the ESS of FIG. 1 in accordance with some demonstrative embodiments;

FIG. 3a illustrates a High Efficiency (HE) Orthogonal Frequency Division Multiple Access (OFDMA) physical layer convergence procedure (PLCP) protocol data unit (PPDU) structure for a 20 MHz communication as defined in 802.11ax;

FIG. 3b illustrates a LP-WU signal multiplexed into an 802.11ax signal in the time domain according to some demonstrative embodiments;

FIG. 4a is a graph plotting Packet Error rate (Per) against receive/Rx power (Prx) in dBm for simulations of some demonstrative embodiments;

FIG. 4b is a graph plotting the miss detection rate against Prx for the same cases as those plotted in FIG. 4a;

FIG. 5 illustrates a LP-WU packet in the time domain in accordance with some demonstrative embodiments;

FIG. 6 illustrates a product of manufacture in accordance with some demonstrative embodiments; and

FIG. 7 illustrates a flow-chart of a method according to some demonstrative embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some demonstrative embodiments may be included in, or substituted for, those of other embodiments. Embodiments set forth in the claims encompass all available equivalents of those claims.

To reduce power consumption in a basic service set (BSS), the idea of using a low-power wake-up receiver (LP-WUR) in Wi-Fi devices has been developed, and has been introduced into the Institute of Electrical and Electronics Engineers (IEEE) 802.11 community in late 2015. Since that time, LP-WUR has received much attention. Recently, a new Study Group (SG) named Wake-Up Receiver (WUR) SG was formed under IEEE 802.11 to study and begin standardization of the new wireless communication protocol as a new amendment to the 802.11 standard specification. The WUR SG has been approved and is slated to be replaced by the 802.11TGba Task Group. The WUR provides a low power solution (for example about 100 μW in an active state, although power amount is not to be considered as limiting) for an always on Wi-Fi or Bluetooth (BT) connectivity of wearable, Internet-of-Things (IoT) or other emerging devices that may be densely deployed. Hereinafter, LP-WUR may be used to refer to the 802.11 LP-WUR wireless communication protocol, or to a LP-WU receiver (that is, receiver circuitry providing LP-WU functionality) that is compliant with such protocol, and the meaning of the acronym will be clear from the context within which it is used.

A concept for LP-WUR has been contemplated which is based on the legacy 802.11a/g/n/ac specification which defines a −82 dBm sensitivity level and using a 4 μsec (3.2 μsec+Cyclic Prefix (CP)) Orthogonal Frequency Division Multiplexing (OFDM) duration with repetition code of 3. To achieve the 4 μsec symbol duration, we consider taking the 64 point Fast Fourier Transform (FFT) on a 20 MHz signal, which would provide a subcarrier spacing of (20 MHze6)/64, which equates to 312.5 KHz. In a time domain, the above would provide a symbol duration of 3.2 μsec (taking the Inverse Fast Fourier Transform (IFFT) as 64/20 MHze6). It is not be noted that, taking into consideration the legacy preambles using a fixed 0.8 μsec guard band, the total symbol duration becomes 4 μsec. In an 802.11ax system, a 256 FFT may be used with 20 MHz giving a subcarrier spacing of 78.125 KHz or a symbol that is 12.8 μsec. In 802.11ax, in addition, we could have guard intervals (such as cyclic prefixes) that are 0.8, 1.6, or 3.2 μsec, resulting in symbol durations of, respectively, 13.6, 14.4 and 16 μsec. The design of the wake-up signal according to this concept is made to be compatible with the 802.11ax Orthogonal Frequency Division Multiple Access (OFDMA) waveform structure, that is, to match the 26-tone allocation of 802.11ax. While compatibility with the 802.11ax OFDMA waveform structure may be an advantage of the signal design associated with this concept (hereinafter, the “⅓ code rate signal design”), a drawback may be the longer symbol duration inherited from the 802.11ax 4× longer OFDM symbol duration. The ⅓ code rate signal design may reduce spectrum efficiency for LP-WU signaling. In essence, the ⅓ code rate signal design, to maintain the duration of the LP-WU symbol as small as 4 μsec, proposes interlacing the LP-WU signal tone assignment with 3 nulls in the frequency domain to obtain a time-domain signal that is repeated 4 times, and to consider only one period out of the four repetitions of the signal to generate and transmit a 4 μsec (3.2 μsec+CP) LP-WU signal resulting therefrom. The LP-WU signal would then be repeated three times to achieve a ⅓ code rate at transmission.

While the IEEE 802.11 specification currently defines a −82 dBm sensitivity level, an actual implementation meets a much lower sensitivity level of less than about −90 dBm. Furthermore, 802.11ax has defined a new Extended Range (ER) mode that provides an extra 3 dB gain in sensitivity level. If a LP-WU signal is to be multiplexed into an 802.11ax signal, its sensitivity would need to be improved accordingly. To achieve the above, demonstrative embodiments propose a ¼ code rate (or repetition code of 4) as opposed to a ⅓ code rate (or repetition code of 3) as noted above. Demonstrative embodiments envision constructing a LP-WU signal that is compatible with an 802.11ax 4× symbol duration, while also carrying 4× repeated transmission.

The new construction of the wake-up signal advantageously integrates coding with the generation of the pulse, and further provides orthogonality to the OFDMA structure of an 802.11ax signal, thus reducing the impact of Out-Of-Band (OOB) emissions. Embodiments advantageously provide a wireless connectivity solution for mobile/wearable/IoT devices that can minimize power consumption while avoiding drawbacks of some solutions noted above.

For example, some demonstrative embodiments interlace 3 nulls within tones assigned to a LP-WU signal in the frequency domain within one 802.11ax OFDMA signal structure of 26 tones (a 26 tone Resource Unit (RU) in 802.11ax). An IFFT of such an allocation would result in a time domain signal with four repeated portions in a transmitted symbol, where the 4× repetition is treated as one bit of transmission of the LP-WU modulated signal for a desired repetition code of 4. The ⅓ code rate signal design may meet higher sensitivity levels than the sensitivity levels associated with the repetition coding rate described herein, for example a repetition code of 4. An alternative repetition code of 4 for the LP-WU signal has also been contemplated as an option, where the bit “1” is coded as “1010” and bit “0” is coded as “0101.” For the latter contemplated concept, each transmitted bit is however disadvantageously either (a) 4× longer than a bit according to demonstrative embodiments here (where bit “1” is coded as one transmission and bit “0” is coded as no transmission), and therefore results in a very long LP-WU packet that leads to inefficient use of the spectrum; or (b) it follows a 4 μsec duration of the pre-11ax amendments, which will results in tones that are not orthogonal to adjacent 802.11ax OFDMA tones.

IEEE 802.11ax uses a 4× symbol duration as compared with IEEE 802.11ac for example, which has a symbol duration of 4 μsec (3.2 μsec+0.8 CP). To multiplex the LP-WU signal into the 802.11ax OFDM tone structure, in the smallest possible RU for such a structure, that is, in a 26 tone RU, the LP-WU signal may have the same bandwidth of 26 tones as that of the 802.11ax signal, along with a tone spacing of 78.125 kHz, resulting in a total symbol bandwidth of 2.03125 MHz for the LP-WU signal. To obtain 4× repetitions within the signal in the time domain, some demonstrative embodiments insert 3 nulls between each tone assigned to/utilized for the LP-WU signal within a 26-tone allocation. For example, a tone allocation including the three interlaced nulls between utilized tones in a LP-WU signal that is at the central 26 tone RU of a OFDMA 802.11ax transmission may be represented by Equation 1 below:

s_ax=α*[0;0;0;0−1−1i;0;0;0;1+1i;0;0;0;1+1i;0;0;0;0;0;0;0;1+1i;0;0;0;1+1i;0;0;0;−1−1i;0;0;0;0] Eq. (1)

where α is a scaling factor that is used to normalize the power per RU or per the entire bandwidth based on the 802.11ax standard specification, as would be recognized by one skilled in the art. The above equation shows 33 tones including the 26 tone RU, and, in addition the 7 DC “0” s at the center of the tone domain because we are at the center 26 tone RU as described. As shown in the example of Equation 1, which represents a symmetrical tone allocation about the DC, the first symbol represents the most negative frequency bin (or a “low side” of the frequency bin), the center is DC at baseband, and the last symbol represents the most positive frequency bin (or a “high side” of the frequency bin. Embodiments however are not limited to a symmetrical tone allocation about DC, and include within their scope a tone allocation that is asymmetrical about the DC. A 256 IFFT of the s_ax sequence would create a 3.2 μsec×4=12.8 μsec time domain sequence with a pattern which repeats four times. The resulting sequence may be transmitted as an On-Off-Keying (OOK) signal with a repetition code of 4 that carries information denoting bit “1”. Absence of such transmission, that is, a silence period, would carry information bit of “0”. A silence period according to some embodiment may correspond either to a complete absence of a transmission of an OFDMA signal including the RU to which the LP-WU is to be allocated, or, it may correspond to a transmission of an OFDMA signal where the RU to which the LP-WU is to be allocated is unassigned/has not energy allocated to it. Equation 1 is only exemplary. Embodiments include within their scope the use of a tone allocation that has nulls inserted between non-zero real or complex tones to create a repetition code in the time domain that allows the tone sequence to present tones that are orthogonal to those of another signal into which the sequence is to be multiplexed. As suggested in Equation 1, for example, inserting 3 nulls between the non-zero tones of a 26 tone RU would generate a corresponding number, in this case 4, of repetitions in the time domain.

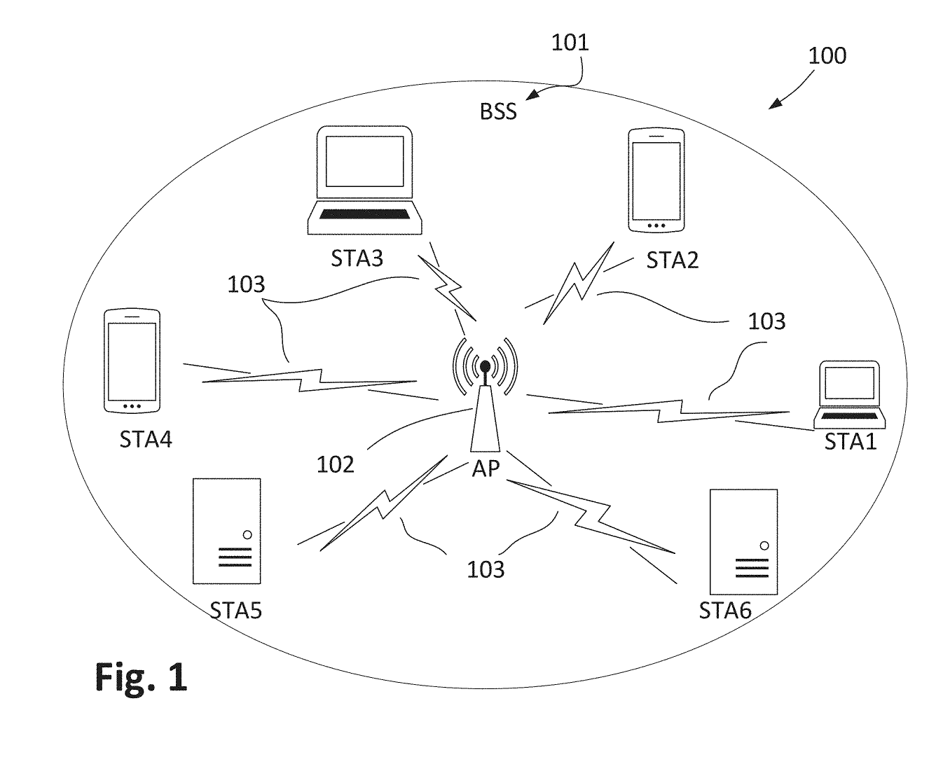

Let us now refer to FIG. 1. FIG. 1 illustrates a Wireless Local Area Network (WLAN) 100 in accordance with some demonstrative embodiments. This is an example of a WLAN which may include devices that may be configured to transmit or receive LP-WU signals multiplexed into a Wi-Fi signals according to some demonstrative embodiments. The WLAN may comprise a Basic Service Set (BSS) 101 that may include an access point (AP), a plurality of HE Wi-Fi (HEW) (e.g., referring to the Institute of Electrical and Electronics Engineers (IEEE) 802.11ax standard) stations (STAs) STA1 and STA2, a plurality of legacy (e.g., IEEE 802.11a/b/g/n/ac) devices STA3 and STA4, and a plurality of IoT devices STA5 and STA6 (e.g., IEEE 802.11ax)

The AP may use one of the IEEE 802.11 wireless communication protocols to transmit and receive. The AP may further include a base station. The AP may use other communications protocols as well as any of the IEEE 802.11 protocols. The IEEE 802.11 protocols may include the IEEE 802.11ax protocol. The IEEE 802.11 protocols may include using orthogonal frequency division multiple-access (OFDMA), time division multiple access (TDMA), and/or code division multiple access (CDMA). The IEEE 802.11 protocols may include a multiple access technique. For example, the IEEE 802.11 protocol may include space-division multiple access (SDMA) and/or multiple-user multiple-input multiple-output (MU-MIMO).

The legacy stations STA3 and STA4 may operate in accordance with legacy wireless communication protocols, such as one or more of IEEE 802.1111a/b/g/n/ac, and/or another legacy wireless communication protocols. The HEW STAs STA1 and STA2 may include wireless transmit and receive devices such as cellular telephones, smart telephones, handheld wireless devices, wireless glasses, wireless watches, wireless personal devices, tablets, or other devices that may be transmitting and receiving using the any of the IEEE 802.11 protocols such as IEEE 802.11ax or another wireless communication protocol. In some demonstrative embodiments, the HEW STAs STA1 and STA2 may be termed high efficiency (HE) stations. The AP may communicate with legacy stations STA3 and STA4 in accordance with legacy IEEE 802.11 communication protocols. In example embodiments, the AP may also be configured to communicate with HEW STAs STA1 and STA2 in accordance with legacy IEEE 802.11 communication techniques.

The IoT devices STA5 and STA6 may operate in accordance with IEEE 802.11ax or another wireless communication protocol of 802.11. The IoT devices STA5 and STA6 may operate on a smaller sub-channel than the HEW stations STA 1 and STA2. For example, the IoT devices STA5 and STA6 may operate on 2.03 MHz or 4.06 MHz sub-channels. In some demonstrative embodiments, the IoT devices STA5 and STA6 may not be able to transmit ore receive on a 20 MHz sub-channel to the AP with sufficient power for the AP to receive the transmission, and may be battery constrained. The IoT devices STA5 and STA6 may be sensors designed to measure one or more specific parameters of interest such as temperature sensor, humidity, or location-specific sensors. IoT devices STA5 and STA6 may be connected to a sensor hub (not illustrated), and may upload data to the sensor hub. The sensor hub may upload the data to an access gateway (not illustrated) that may connect several sensor hubs to a cloud sever. The AP may act as the access gateway in accordance with some demonstrative embodiments. The AP may act as the sensor hub in accordance with some demonstrative embodiments. In some other demonstrative embodiments, the IoT devices STA5 and STA6 may need to consume very low average power in order to perform a packet exchange with the AP.

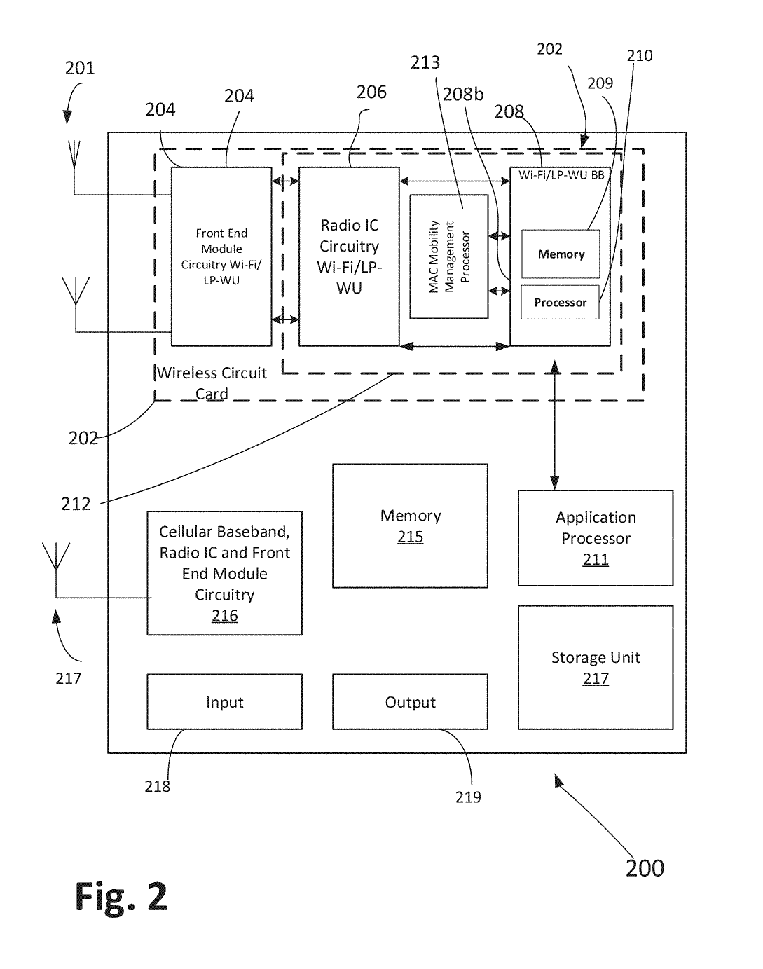

In some demonstrative embodiments, the AP may be adapted to send low-power wake-up (LP-WU) packets to the HEW stations STA1 and STA2, and/or IoT devices STA5 and STA6 that may be adapted to receive and decode packets configured according to an IEEE Low-Power Wake-Up Receiver (LP-WUR) wireless communication protocol. Communication compliant with the LP-WUR wireless communication protocol may be made possible through the use of a low-power wake-up receiver, e.g., one that uses 100 μW in a listen state, as will be described further below in relation to FIG. 2. Although 100 μW is mentioned here, it is merely an example of the power used in a listen state. Embodiments encompass LP-WURs that use lower or high power, such as, for example, a few hundred μW. LP-WUR compliant stations within the BSS of FIG. 1 that have entered a power save mode may exit the power save when they receive and decode a LP-WU signal.

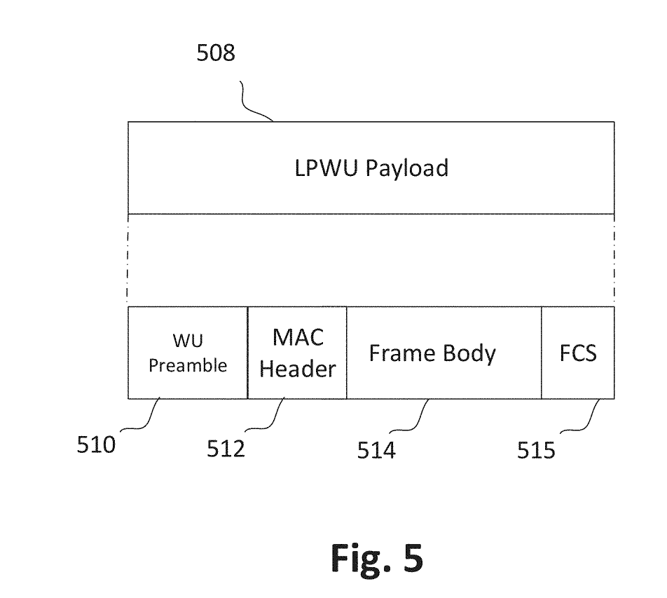

In some demonstrative embodiments, the AP, HEW stations STA1 and STA2, legacy stations STA3 and STA4, and/or IoT devices STA5 and STA6 may enter a power save mode and exit the power save mode periodically or at pre-scheduled times to see if there is a packet for them to be received. Those stations that are LP-WUR compliant may enter a power save mode and remain in the power save mode at least until they receive a LP-WU packet from another station within the BSS. The power save mode may be a deep power save mode. A LP-WUR of a station may remain in a listen mode to receive a LP-WU packet or payload 508, which will be described in further detail in FIG. 5. The LP-WU packet may include information on an identifier/address of the receiving station including the LP-WUR, such that the receiving station may exit its low power state when the LP-WU packet includes its identifier and process that LP-WU packet.

In some demonstrative embodiments, a HEW signal may be communicated on a subchannel that may have a bandwidth of 20 MHz, 40 MHz, or 80 MHz, 160 MHz, or 320 MHz contiguous bandwidths or an 80+80 MHz (160 MHz) non-contiguous bandwidth. In some demonstrative embodiments, the bandwidth of a HEW subchannel may be 2.03125 MHz, 4.0625 MHz, 8.28125 MHz, a combination thereof, or another bandwidth that is less or equal to the available bandwidth may also be used. The subchannel may include a number of tones or tones, such as 26, and these tones may include a combination of data tones and other tones. The other tones may include DC nulls, guard intervals, or may be used for any purpose other than carrying data.

A HEW packet may be configured for transmitting a number of spatial streams, which may be in accordance with MU-MIMO. In other embodiments, the AP, HEW STAs STA1 and STA2, and/or legacy stations STA3 and STA4 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, or other technologies.

Some demonstrative embodiments relate to HEW communications. In accordance with some IEEE 802.11ax embodiments, an AP may be configured to contend for a wireless medium (e.g., during a contention period) to receive exclusive control of the medium for an HEW control period. In some demonstrative embodiments, the HEW control period may be termed a transmission opportunity (TXOP). The AP may transmit a HEW master-sync transmission, which may be a trigger packet or HEW control and schedule transmission, at the beginning of the HEW control period. The AP may transmit a time duration of the TXOP and sub-channel information. During the HEW control period, HEW STAs STA1 and STA2 may communicate with the AP in accordance with a non-contention based multiple access technique such as OFDMA and/or MU-MIMO.

The above is unlike conventional Wi-Fi communications in which devices communicate in accordance with a contention-based communication technique, rather than a multiple access technique. During the HEW control period, the AP may transmit a LP-WU packet to various ones of the stations that LPWUR functionality. During the HEW control period, a LP-WUR included in a STA, such as in any one of the STAs of FIG. 1, may operate on a sub-channel smaller than the operating range of the AP. During a HEW control period, legacy stations refrain from communicating.

In accordance with some demonstrative embodiments, during a master-sync transmission, the LP-WUR may receive a LP-WU packet and then may wake up the HEW STAs STA1 and STA2 or IoT STAs STA5 and STA6, which then may contend for the wireless medium with the legacy stations STAs STA3 and STA4 being excluded from contending for the wireless medium during the master-sync transmission. In some demonstrative embodiments, HEW STAs STA1 and STA2 or IoT STAs 108 may communicate with the AP in accordance with a non-contention based access technique after being woken up and obtaining the UL transmit configuration from a trigger packet which may indicate an uplink (UL) UL-MU-MIMO and/or UL OFDMA control period.

In some demonstrative embodiments, the multiple-access technique used during the HEW control period may be a scheduled OFDMA technique, although this is not a requirement. In some demonstrative embodiments, the multiple access technique may be a time-division multiple access (TDMA) technique or a frequency division multiple access (FDMA) technique. In some demonstrative embodiments, the multiple access technique may be a space-division multiple access (SDMA) technique.

The AP may also communicate with legacy stations STAs STA3 and STA4 and/or HEW stations STA5 and STA6 in accordance with legacy IEEE 802.11 communication techniques. In some demonstrative embodiments, the AP may also be configurable to transmit a LP-WU packet to a LP-WUR outside the HEW control period in accordance with legacy IEEE 802.11 communication techniques, although this is not a requirement.

Reference will now be made to FIG. 2. FIG. 2 depicts one embodiment of a STA, or one embodiment of a AP, such as the AP, or HEW or IoT STAB shown in FIG. 1, as would be recognized by a skilled person, although embodiments are not so limited. At certain points within the below description, FIG. 2 will be referred to as an apparatus including an architecture for a STA 200, while at certain other points within the below description, FIG. 2 will be referred to as an apparatus including an architecture for an AP 200. The context will however be clear based on the description being provided.

Referring next to FIG. 2, a block diagram is shown of a wireless communication system such as STA 200 or AP 200 (hereinafter STA/AP 200) such as any of STA1, STA2, STA5 or STAG, or the AP of FIG. 1, according to some demonstrative embodiments. A wireless communication apparatus may include a wireless communication radio architecture 201 in accordance with some demonstrative embodiments. Radio architecture 201 may include radio front-end module (FEM) circuitry 204, radio IC circuitry 206 and baseband processor 208. Radio architecture 201 as shown includes both Wi-Fi functionality and LP-WUR functionality, although embodiments are not so limited. LP-WUR/LP-WU may refer to Medium Access Control Layer and Physical Layer specifications in accordance with efforts within the Institute of Electrical and Electronics Engineers (IEEE)'s regarding a LP-WUR standard.

In FIG. 2, it is to be noted that the representation of a single antenna may be interpreted to mean one or more antennas. Although FIG. 2 shows a single radio IC circuitry block 206, a single FEM circuitry block 204 and a single baseband circuitry block 208, where each of the above blocks could include both Wi-Fi and LP-WU functionality, these blocks are to be viewed as representing the possibility of one or more circuitry blocks, where potentially one set of distinct circuitry blocks, for example, a distinct FEM circuitry, a distinct radio IC circuitry, and/or a distinct LP-WU baseband circuitry would work to provide the noted LP-WU functionality. In the alternative, such functionality could be integrated either in part or in whole within the Wi-Fi circuitry. In the alternative, components providing LP-WU functionality could be provided, according to some demonstrative embodiments, within circuitry blocks positioned off of the IC 212 or wireless radio card 202, for example adjacent the application processor 211. Also, as used herein, “processing circuitry” or “processor” may include one or more distinctly identifiable processor blocks.

FEM circuitry 204 may include both Wi-Fi functionality (which would allow the processing of Wi-Fi signals) and LP-WU functionality (which would allow the processing of LP-WU signals). The FEM circuitry 204 may include a receive signal path comprising circuitry configured to operate on Wi-Fi and LP-WU RF signals received from one or more antennas 201, to amplify the received signals and to provide the amplified versions of the received signals to the radio IC circuitry 206 for further processing. FEM circuitry 204 may also include a transmit signal path which may include circuitry configured to amplify signals provided by the radio IC circuitry 206 for wireless transmission by one or more of the antennas 201. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC circuitry 206 may include both Wi-Fi and LP-WU functionality, and may include therein a distinct LP-WU radio to process an LP-WU only portion of a signal that includes a LP-WU signal multiplexed into a Wi-Fi signal. Radio IC circuitry 206 as shown may include a receive signal path which may include circuitry to down-convert signals received from the FEM circuitry 204 and provide baseband signals to baseband processor 208. The radio IC circuitry 206 may also include a transmit signal path which may include circuitry to up-convert baseband signals provided by the baseband processor 208 and provide RF output signals to the FEM circuitry 204 for subsequent wireless transmission by the one or more antennas 201. In addition, embodiments include within their scope the provision of a radio IC circuitry that allows transmission of LP-WU signals.

Baseband processing circuitry 208 may include processing circuitry that provides Wi-Fi functionality (hereinafter, main baseband processor), and processing circuitry that provides LP-WU functionality (hereinafter low-power baseband processor). In the instant description, the baseband processing circuitry 208 may include a memory 209, such as, for example, a set of RAM arrays in a Fast Fourier Transform or Inverse Fast Fourier Transform block (not shown) of the baseband processor 208. Processing circuitry 210 may include control logic to process the signals received from the receive signal path of the radio IC circuitry 206. Baseband processing circuitry 208 is also configured to also generate corresponding baseband signals for the transmit signal path of the radio IC circuitry 206, and may further include physical layer (PHY) and medium access control layer (MAC) circuitry, and may further interface with application processor 211 for generation and processing of the baseband signals and for controlling operations of the radio IC circuitry 206. Referring still to FIG. 2, according to the shown embodiment, a MAC mobility management processor 213 may include a processor having logic to provide a number of higher MAC functionalities. For example, processor 213 may instruct the waking up of the main processor, such as the Wi-Fi processor, based on the device receiving and decoding a LP-WU signal. In the alternative, or in conjunction with the MAC mobility management processor 213, some of the higher-level MAC functionalities above may be provided by application processor 211.

In some demonstrative embodiments, the front-end module circuitry 204, the radio IC circuitry 206, and baseband processor 208 may be provided on a single radio card, such as wireless radio card 202. In some other embodiments, the one or more antennas 201, the FEM circuitry 204 and the radio IC circuitry 206 may be provided on a single radio card. In some other embodiments, the radio IC circuitry 206 and the baseband processor 208 may be provided on a single chip or integrated circuit (IC), such as IC 212.

In some demonstrative embodiments, the wireless radio card 202 may include a Wi-Fi radio card and may be configured for Wi-Fi communications, although the scope of the embodiments is not limited in this respect. In some of these embodiments, the radio architecture 201 may be configured to receive and transmit OFDM or OFDMA communication signals over a multicarrier communication channel.

In some other embodiments, the radio architecture 201 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some demonstrative embodiments, the radio-architecture 200 may include other radio cards, such as a cellular radio card configured for cellular (e.g., 3GPP such as LTE, LTE-Advanced or 5G communications).

In some IEEE 802.11 embodiments, the radio architecture 201 may be configured for communication over various channel bandwidths including bandwidths having center frequencies of 900 MHz, 2.4 GHz, 5 GHz, and bandwidths of less than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 2, in some demonstrative embodiments, STA/AP 200 may further include an input unit 218, an output unit 219, a memory unit 215. STA/AP 200 may optionally include other suitable hardware components and/or software components. In some demonstrative embodiments, some or all of the components of STA/AP 200 may be enclosed in a common housing or packaging, and may be interconnected or operably associated using one or more wired or wireless links. In other embodiments, components of STA/AP 200 may be distributed among multiple or separate devices.

In some demonstrative embodiments, application processor 211 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 211 may execute instructions, for example, of an Operating System (OS) of STA/AP 200 and/or of one or more suitable applications.

In some demonstrative embodiments, input unit 218 may include, for example, one or more input pins on a circuit board, a keyboard, a keypad, a mouse, a touch-screen, a touch-pad, a track-ball, a stylus, a microphone, or other suitable pointing device or input device. Output unit 219 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 215 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units. Storage unit 217 may include, for example, a hard disk drive, a floppy disk drive, a Compact Disk (CD) drive, a CD-ROM drive, a DVD drive, or other suitable removable or non-removable storage units. Memory unit 215 and/or storage unit 217, for example, may store data processed by STA/AP 200.

Referring still to the demonstrative embodiment of FIG. 2, a LP-WUR of a wireless radio card may include, circuitry within FEM 204, within radio IC 206 and within baseband processing circuitry 208 that provide LP-WU functionality. According to some other embodiments, the device shown in FIG. 2 may have more than one FEM or radio IC circuitry or baseband circuitry to provide the Wi-Fi plus LP-WU functionality.

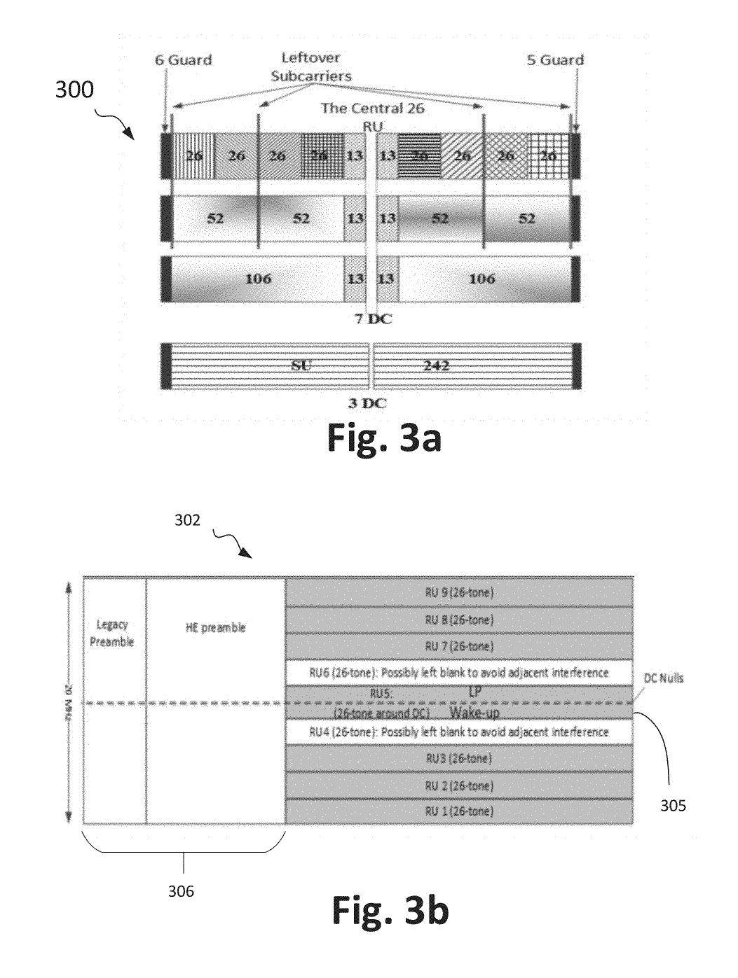

Referring next to FIG. 3a, a High Efficiency (HE) OFDMA physical layer convergence procedure (PLCP) protocol data unit (PPDU) structure 300 is shown for a 20 MHz communication as defined in 802.11ax. A HE OFDMA PPDU according to 802.11ax can carry a mixture of 26-tone, 52-tone and 106-tone RU sizes within any of the 242-tone RU boundaries as shown in FIG. 3a, and communications in 802.11ax may span 20 MHz, 40 MHz, 80 MHz, 160 MHz and a non-contiguous 80+80 MHz bandwidth. Although an exemplary RU distribution is shown for 20 MHz in FIG. 3a with 26 tone, 52 tone, 106 tone and 242 tone RUs, embodiments for example contemplate the use of any of the above bandwidths and any of the above number of tones per given bandwidth.

The shown 802.11ax top 26 RU 20 MHz band in FIG. 3a show the 9 RUs at fixed RU tone indices, and, additionally, 7 DC nulls, 11 guard bands with null/leftover tones. For the example of a 20 MHz HE OFDMA PPDU transmission, the 20 MHz is divided into 256 tones, with the signal being transmitted on tone −122 to −4 and 4 to 122, with 7 zeros being at the center (DC) tone. According to some demonstrative embodiments, successive bits of a LP-WU packet may be multiplexed into corresponding smallest RUs of successive transmissions, such as, for example, into corresponding 26 tone RUs of successive transmission such as the 20 MHz transmission shown in FIG. 3a, with the rest of available smallest RU in a given transmission being used for 802.11ax PPDUs as will be explained further below, the PPDUs being for a main radio different from the main radio to be awakened by the LP-WU packet multiplexed into the shown structure.

Referring next to FIG. 3b, an OFDMA packet structure 302 is shown for a 20 MHz 9 RU 26 tone bandwidth transmission in conformance with 802.11ax, further suggesting that LP-WU symbols are modulating OFDMA symbols in the central 26 tone RU, RU5, according to some demonstrative embodiments. As shown in FIG. 3b, according to one embodiment, a LP-WU signal 308 may be multiplexed onto the OFDMA signal that is allocated to the central 26 tone RU as shown, that is, RU5, with adjacent RUs, that is RUs 4 and 6 possibly nulled to avoid adjacent interference, although embodiments are not so limited. The packet structure 302 further includes a preamble 306 also spanning the entire bandwidth of the transmission, that is 20 MHz, the preamble including a legacy preamble and a HE preamble in conformance with 802.11ax. Preamble 306 may include a legacy short-training field (L-STF), a legacy long training field (L-LTF), and a legacy signal (L-SIG) field (not shown), and an HE preamble in compliance with 802.11ax. According to other embodiments, preamble 306 may be in compliance with another communication standard, such as Bluetooth. In some demonstrative embodiments, a LP-WUR may ignore the legacy preamble 306. The legacy preamble would allow legacy 802.11 STAs to detect the beginning of the compound packet (that is, packet including the first signal multiplexed into the second signal) through L-STF, and the end of the same through information within the L-SIG, while the HE preamble would allow HE STAs to detect among other things whether the compound packet includes HE signals. The HE preamble may also include one or more STA identifiers for the STAs that are to process the OFDMA signals in the assigned RUs of the OFDMA packet. As noted previously, the HE preamble portion may signal to an intended receiver, such as an intended LP-WU receiver, that an OFDMA modulated data symbol is on its way, and that a predetermined RU (such as the central RU5) includes an OFDMA modulated data signal that ought to be used by the LP-WU receiver as an OOK modulated LP-WU signal equal to a bit value of “1.” The LP-WU receiver would then know to decode an absence of an OFDMA modulated data signal in the predetermined RU, such as RU5, as a bit value of “0”. A set of OFDMA signals thus allocated to corresponding predetermined RUs of successive transmissions, such as corresponding RU5's of successive OFDMA signal transmissions, interspersed with some nulled versions of RU5, would present a sequence of bit values of 1 's and 0's that would be decoded on the LP-WU receiver side as an OOK LP-WU packet.

This packet could be used to cause a wake-up of the main radio, such as an 802.11ax radio, such that this main radio could then demodulate subsequent OFDMA signals after waking up, from the transmitter that sent the multiplexed OFDMA signal including the OOK LP-WU signal, and/or from other transmitters. Demonstrative embodiments that include a multiplexing of a LP-WU signal onto an OFDMA signal will be explained in further detail below.

As used in this disclosure, “tone” and “subcarrier” are used interchangeably. Moreover, when “at least one of” a given set or list of items connected with “and” is mentioned herein, what is meant is a reference to either one of the noted items, or any combination of the items. For example, as used herein, “at least one of A, B and C” means “A, or B, or C, or A and B, or A and C, or B and C, or A and B and C.”

According to some demonstrative embodiments, a wireless communication device, such as a baseband processor, for example a baseband processor of an AP, may comprise a memory and processing circuitry coupled to the memory. The processing circuitry may include logic to multiplex a first signal into a second signal. The multiplexing may be achieved by encoding the first signal and second signal using orthogonal frequency divisional multiple access (OFDMA). The first signal may be contained within one of a plurality of smallest resource units (smallest RUs) of a second signal. The first signal and the second signal may have a same number of tones and a same tone spacing in a frequency domain, and a same symbol duration in a time domain. The first signal may present a sequence including number of repeated portions in a time domain and a number of nulls in a frequency domain, the sequence representing an information bit of “1”. The logic may further cause transmission of a multiplexed signal including the first signal and the second signal, where the first signal is multiplexed into the second signal.

According to some demonstrative embodiments, a wireless communication device, such as, for example, a baseband processing circuitry of a STA, may comprise a memory and processing circuitry coupled to the memory, the processing circuitry including a main baseband processor and a low power baseband processor, the processing circuitry further including logic to cause the low-power baseband processor to process a first signal in a multiplexed signal including the first signal and a second signal, wherein the first signal and the second signal use orthogonal frequency divisional multiple access (OFDMA). The first signal may be contained within one of a plurality of smallest resource units (smallest RUs) of a structure of a second signal, and the first signal and the second signal may have a same number of tones and a same tone spacing in a frequency domain, and a same symbol duration in a time domain. The first signal may present a sequence including number of repeated portions in a time domain and a number of nulls in a frequency domain, the sequence representing an information bit of “1”. The logic may cause a wake-up of the main baseband processor based on the first signal. The logic may further cause the main baseband processor to process subsequent OFDMA signals after waking up after waking up.

Reference will now be made to FIGS. 1, 2, 3a, 3b and 5 in order to describe some demonstrative embodiments, although it is to be noted that embodiments are not limited to what is described below and shown with respect to FIG. 1, or 2, or 3a or 3b, or 5, or any of the other figures included herein.

According to some demonstrative embodiments, a wireless communication device, such as a baseband processor 208 within the AP 200 of FIG. 2, may comprise a memory 209 and processing circuitry 210 coupled to the memory 209. The processing circuitry 210 may include logic to multiplex a first signal into a second signal. The first signal may include a LP-WU signal, and the second signal may include a Wi-Fi signal, such as an 802.11ax signal, although embodiments are not so limited. For example, the second signal may be a Bluetooth signal, or a signal in conformance with any other communication protocol, whether wired or wireless, as would be recognized by a skilled person. The multiplexing may be achieved by encoding the first signal and second signal using orthogonal frequency divisional multiple access (OFDMA). The first signal may be contained within one of a plurality of smallest resource units (smallest RUs) of a structure of a second signal. For example, referring to FIG. 3a, the first signal, that is, for example, a signal for the LP-WU packet 508 of FIG. 5, may be contained within one of a plurality of smallest RUs, such as one of a plurality of 26 tone RUs of a 20 MHz transmission, as shown by way of example in FIGS. 3a and 3b, the RUs being part a packet structure such as packet structure 302 illustrated in FIG. 3b. The second signal would include the remaining part of the multiplexed signal not including the header (such as the legacy and HE preambles), one that does not include the LP-WU signal. The first signal and the second signal may have a same number of tones and a same tone spacing in a frequency domain. For example, in the shown embodiment of FIG. 3b, the first signal 308 that is contained within central RU5 has a same symbol duration in a time domain as the symbols in the other RUs in the packet 300. The first signal may present a sequence including number of repeated portions in a time domain and a number of nulls in a frequency domain, the sequence representing an information bit of “1”. For example, the first signal may have a tone allocation as represented by Equation 1 above, or any other tone allocation where there are nulls placed in between each utilized (non-zero real or complex) tone of a resource unit to create a corresponding number of repetitions for the signal in the time domain. For example, the interlacing of three nulls placed between each set of non-zero tones in a 26 tone RU may result in a repetition of 4. The logic may further cause transmission of a multiplexed signal, such as a signal with packet structure 302, including the first signal and the second signal, where the first signal is multiplexed into the second signal, as shown by signal 308 having been multiplexed into the signal whose packet structure is shown as packet 302 in FIG. 3b.

According to some demonstrative embodiments, the first signal may be a LP-WU signal with a bandwidth of at least 2.031 MHz, and the second signal may be an 802.11ax signal with a bandwidth of 20 MHz, although embodiments are not so limited. In order for the first signal to be multiplexed into the second one, the tone spacing of both signals may be 78.125 kHz, the symbol duration may be 12.8 μs, and the first signal and the second signal may both have a FFT size of 256. One of a number of features that may differentiate the first signal from the second signal is that the first signal may have a modulation that may be lower than a lowest modulation for the first signal. For example, the first signal may have an OOK modulation, while a lowest possible modulation for the second signal may be for example Binary Phase Shift Keying or BPSK. The latter is the case for example when the first signal is a LP-WUR signal, and the second signal is an 802.11ax signal. According to some demonstrative embodiments, the signal may have a contiguous bandwidth of 20 MHz, 40 MHz, 80 MHz, 160 MHz, or 320 MHz, or a non-contiguous bandwidth of 80+80 MHz (160 MHz). As further seen in FIG. 3b, a baseband processing circuitry such as baseband processing circuitry 208, may generate a preamble for the signal, as shown for example by preamble 306 in FIG. 3b.

According to some demonstrative embodiments, a wireless communication device, such as a baseband processor 208 within the STA 200 of FIG. 2, may comprise a memory 209 and processing circuitry 210 coupled to the memory 209. The processing circuitry may include a low-power baseband processor (such as the circuitry within baseband processing circuitry 208 that allows LP-WU functionality), and a main baseband processor (such as the circuitry within baseband processing circuitry 208 that allows Wi-Fi functionality). The processing circuitry 210 may include logic to process a first signal multiplexed into a signal that also includes a second signal. The first signal may include a LP-WU signal, and the second signal may include a Wi-Fi signal, such as an 802.11ax signal, although embodiments are not so limited. A multiplexing of the first signal into the second signal has already been described above. The logic may cause the low-power baseband processor within baseband circuitry 208 to process the first signal, such as the LP-WU packet 308 of FIG. 3b, or the LP-WU packet 508 shown in FIG. 5. If this packet is sensed, the logic may then cause, for example by using MAC mobility management processor 213, or application processor 211, a wake-up of the main baseband processor, this wake-up being based on the first signal, for example on the LP-WU signal. A waking of the main baseband processor within baseband processing circuitry 208 may then cause the main baseband processor to process subsequent OFDMA signals after waking up, such as the Wi-Fi signal, such as for example the payloads within RUs 1-3 and 7-9 in FIG. 3b.

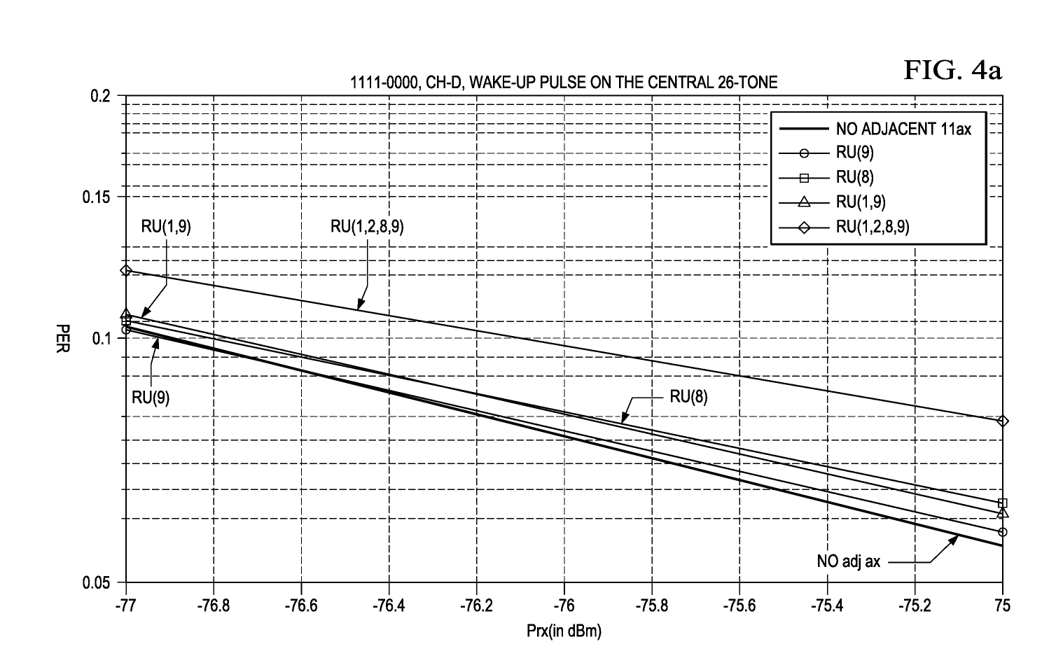

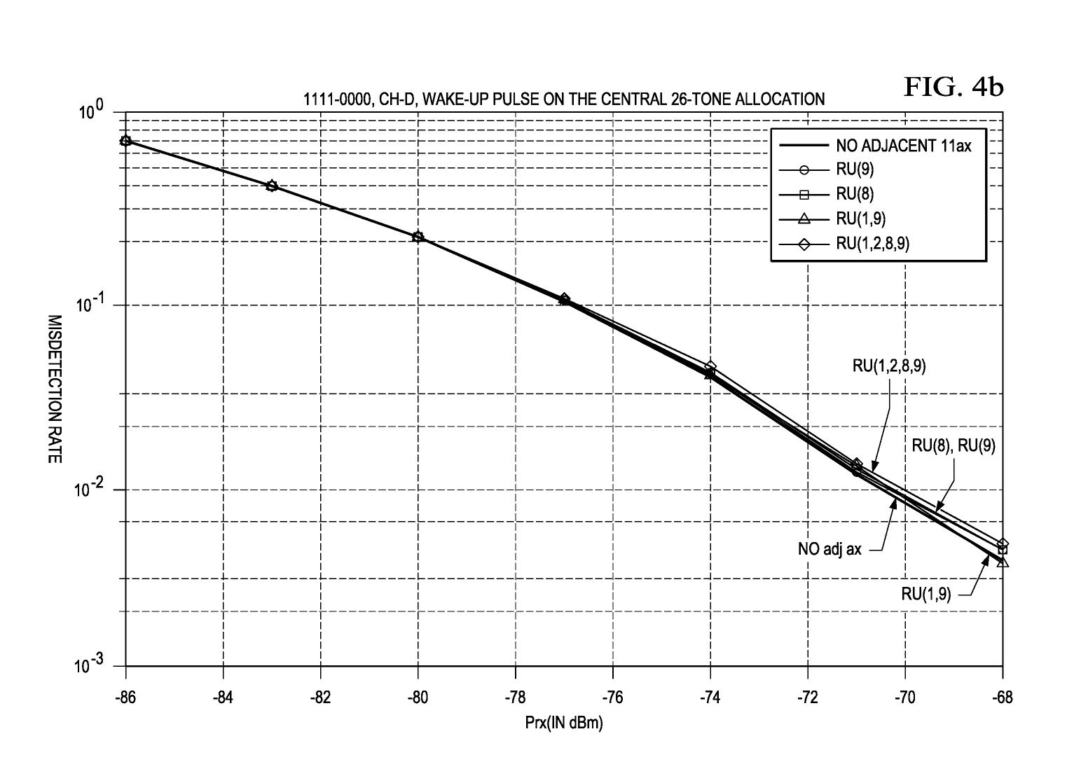

Referring next to FIG. 4a and FIG. 4b, the OFDMA structure of FIG. 3a was used for simulations. In addition to the transmission of the LP-WU packet, zero, one, two and four 802.11ax OFDMA PPDU were multiplexed within the shown 20 MHz bandwidth with the LP-WU packet. The above was done in order to allow studying the adjacent channel interference on a LP-WUR, which tends to have considerable phase-noise (the very low power consumption of about 100 μW in a LP-WUR is afforded by virtue of relaxing its phase-noise requirements). In this configuration of the packet structure, we assume again that RUs adjacent to the central 26 tone RU containing the LP-WU packet are to be left unassigned (have no energy allocated to them) to function as guard bands to reduce the impact of adjacent channel interference on the LP-WUR. Results were obtained for a LP-WUR that uses a 4 MHz receive (Rx) filter, at −65 dBc/Hz at 1 MHz phase noise and random phase offset uniformly distributed between 0 to 2π added to the received LP-WU packet. The simulations results were attained using IEEE channel model D.

FIG. 4a shows the Rx power (Prx) in dBm on the x axis, and the packet error rate (Per) on the y axis, while FIG. 4b shows Prx on the x axis, and the miss detection rate (probability of a missed signal detection) on the y axis, for the same simulations as those that were used as the basis for the graph in FIG. 4a and described above. FIGS. 4a and 4b suggest among other things that some proposed embodiments bring about negligible performance loss for example when multiplexing 1 or 2 simultaneous 802.11ax transmission with a LP-WU transmission. The graphs further suggest that, when 801.11ax transmissions are multiplexed with a LP-WU transmission, there is a negligible loss of about 0.6 dB in the packet error performance only.

Referring next to FIG. 5, a LP-WU packet 508 according to an exemplary embodiment is shown. The packet 508 may be transmitted on a 2.03125 MHz, 4.0625 MHz, or 8.28125 MHz channel. The LP-WU packet 508 may include a Wake-Up Preamble 510, a MAC header 512, a frame body 514, and a frame check sequence field (FCS) 516 for error correction. The LP-WU packet 508 may include information in a field, such as in the MAC header 512 or in the frame body 514, regarding an identifier/address for the STA for which the LP-WU packet is destined. The other RUs that carry 802.11ax PPDUs would be addressed to radios other than the one to be awakened by the LP-WU packet 508. In some demonstrative embodiments, the LP-WU packet 508 may be encoded by transmitting or not transmitting a wake-up pulse one or more times, with a transmission counting as bit “1”, and a lack of transmission counting as a bit “0”, in this way achieving OOK modulation. For example, the repetitions for the LP-WU packet in the time domain brought about as a result of interlacing the 3 nulls within the tones in the frequency domain may be transmitted or not transmitted, and may be used to encode a bit “1” when transmitted, and a bit “0” when not transmitted.

In some demonstrative embodiments, the LP-WU packet 508 may be transmitted in a central portion of the channel the preamble 306 of FIG. 3b is transmitted on. The packet 508 may use a different modulation as compared with the modulation of the preamble, such as OOK or Frequency Shift Keying (FSK).

The wake-up preamble 510 may include a sequence of wake-up pulses, and may be generated by OOK modulation of a pattern (e.g., [1 1 0 . . . 1 0]). For each 1 in the pattern, the pulse is transmitted and for each 0 in the pattern, the pulse is not transmitted, in accordance with some demonstrative embodiments. According to an exemplary embodiment, the MAC header 512 may be a header that includes a source address or identifier for the source generating the pulse, or a destination address or identifier for the STA to which the LP-WU packet is destined or both. In the alternative, the frame body or LP-WU packet 508 may be the body of the frame that includes one or more of the above identifiers. The identifier may be an identifier of one or more LP-WURs within STAs to which the LP-WU packet may be addressed. According to some demonstrative embodiments, one LP-WU could be addressed to multiple STAs. According to some other demonstrative embodiments, more than one first signal may be multiplexed into the second signal. For example, more than one LP-WU signal may be multiplexed into an 802.11ax OFDMA structure (for example in distinct RUs of the structure), each packet destined to one or more corresponding STAs. Alternatively, the identifier may indicate that an LP-WU packet is for one or more LP-WURs with a given identifier within a number of STAs. The FCS 515 may include information for a LP-WUR to check the integrity of the packet 508.

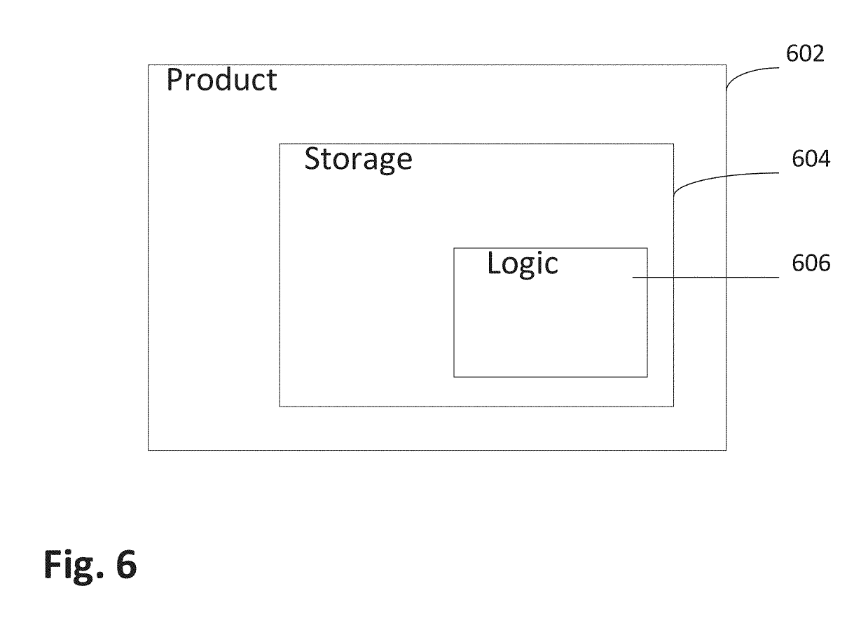

FIG. 6 illustrates a product of manufacture 600, in accordance with some demonstrative embodiments. Product 600 may include one or more tangible computer-readable non-transitory storage media 602, which may include computer-executable instructions, e.g., implemented by logic 604, operable to, when executed by at least one computer processor, enable the at least one computer processor to implement one or more operations at one or more STAs or APs, and/or to perform one or more operations described above with respect to FIGS. 1, 2, 3a, 3b, 4 and 5, and/or one or more operations described herein. The phrase “non-transitory machine-readable medium” is directed to include all computer-readable media, with the sole exception being a transitory propagating signal.

In some demonstrative embodiments, product 600 and/or storage media 602 may include one or more types of computer-readable storage media capable of storing data, including volatile memory, non-volatile memory, removable or non-removable memory, erasable or non-erasable memory, writeable or re-writeable memory, and the like. For example, storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

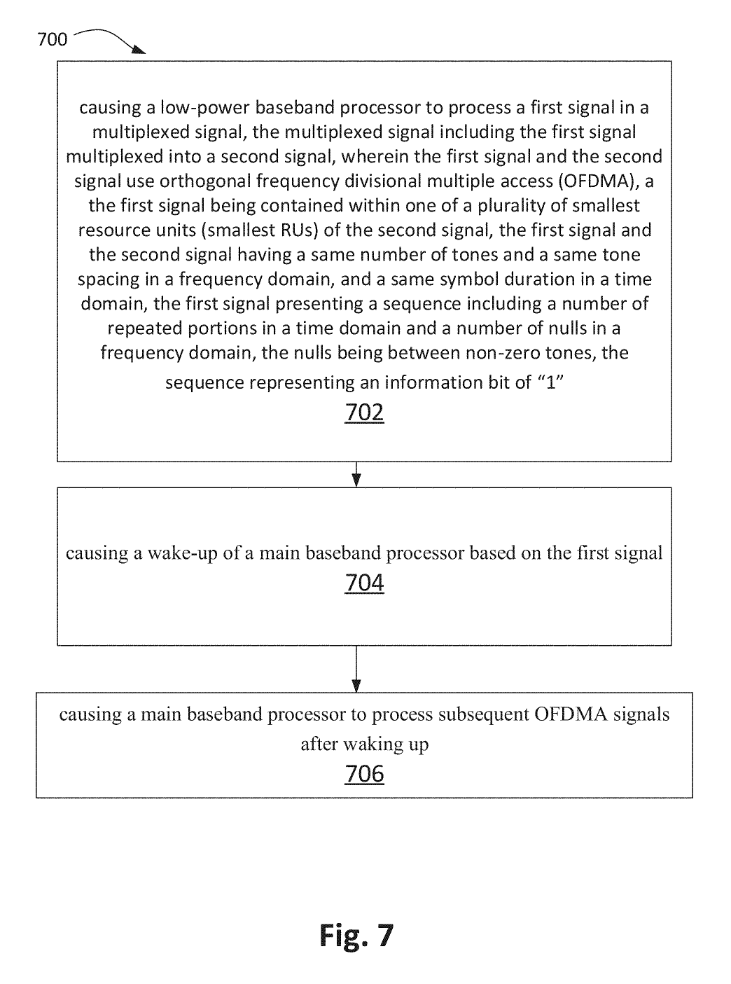

FIG. 7 illustrates a method 700 of multiplexing a first signal into a second signal in accordance with some demonstrative embodiments. The method 700 may begin with operation 702, which includes causing a low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”. At operation 704, the method includes causing wake-up of a main baseband processor based on the first signal. At operation 706, the method further includes **.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the device 200 of FIG. 2 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device comprising a memory and processing circuitry coupled to the memory, the processing circuitry including a main baseband processor and a low power baseband processor, the processing circuitry further including logic to cause the low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”. The logic is to further cause a wake-up of the main baseband processor based on the first signal; and cause the main baseband processor to process subsequent OFDMA signals after waking up.

Example 2 includes the subject matter of Example 1, and optionally, wherein the multiplexed signal includes a plurality of multiplexed signals, and the first signal includes a plurality of first signals, each of the multiplexed signals including a corresponding one of the first signals, the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 3 includes the subject matter of Example 1, and, optionally, wherein there exist three nulls between each pair of non-zero real or complex tones of the first signal in the frequency domain.

Example 4 includes the subject matter of Example 1, and, optionally, wherein the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256; the second signal has guard bands of 0.8, 1.6, or 3.2 μsec; and the smallest RUs include 26 tones.

Example 5 includes the subject matter of Example 1, and, optionally, wherein a modulation of the first signal is On-Off Keying (OOK).

Example 6 includes the subject matter of any one of Examples 1-5, and optionally, wherein the multiplexed signal has a contiguous bandwidth of 20 MHz, 40 MHz, 80 MHz, 160 MHz, or 320 MHz, or a non-contiguous bandwidth of 80+80 MHz (160 MHz).

Example 7 includes the subject matter of any one of Examples 1-5, and optionally, wherein the first signal is contained within a central RU of the second signal.

Example 8 includes the subject matter of any one of Examples 1-5, and optionally, wherein one or more RUs adjacent the one RU of the plurality of smallest RUs are unassigned.

Example 9 includes the subject matter of any one of Examples 1-5, and optionally, wherein the second signal further carries information indicating an identifier for the wireless device.

Example 10 includes the subject matter of any one of Examples 1-5, and optionally, wherein the first signal is in conformance with an Institute of Electrical and Electronics Engineers (IEEE) 802.11ax wireless communication protocol; and the second signal is in conformance with an IEEE Low-Power Wake-Up Receiver wireless communication protocol.

Example 11 includes the subject matter of Example X-1, and, optionally, any one of claims 1-5, further comprising a radio; and a front-end module coupled to the radio.

Example 12 includes the subject matter of Example 11, and, optionally, further including one or more antennas connected to the front-end module.

Example 13 includes a product comprising one or more tangible computer-readable non-transitory storage media comprising computer-executable instructions operable to, when executed by at least one computer processor, enable the at least one computer processor to implement operations at a wireless communication device, the operations comprising: cause a low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”; and causing a main baseband processor to process subsequent OFDMA signals after waking up.

Example 14 includes the subject matter of Example 13, and optionally, wherein the multiplexed signal includes a plurality of multiplexed signals, and the first signal includes a plurality of first signals, each of the multiplexed signals including a corresponding one of the first signals, the logic to cause the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 15 includes the subject matter of Example 13, and optionally, wherein there exist three nulls between each pair of non-zero real or complex tones of the first signal in the frequency domain.

Example 16 includes the subject matter of Example 13, and optionally, wherein: the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256; the second signal has guard bands of 0.8, 1.6, or 3.2 μsec; and the smallest RUs include 26 tones.

Example 17 includes the subject matter of Examples 13-16, and optionally, wherein a modulation of the first signal is On-Off Keying (OOK).

Example 18 includes the subject matter of any one of Examples 13-16, and optionally, wherein: the first signal is contained within a central RU of the second signal; and the RUs adjacent the central RU are unassigned.

Example 19 includes the subject matter of any one of Examples 13-16, and optionally, wherein the second signal further carries information indicating an identifier for the wireless device.

Example 20 includes the subject matter of any one of Examples 13-16, and optionally, further comprising: a radio; and a front-end module coupled to the radio.

Example 21 includes the subject matter of Example 20, and optionally, further including one or more antennas connected to the front-end module.

Example 22 includes a method to be performed at a wireless communication device, the method comprising: cause a low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”; causing a wake-up of a main baseband processor based on the first signal; and causing the main baseband processor to process subsequent OFDMA signals after waking up.

Example 23 includes the method of Example 22, and optionally, wherein the multiplexed signal includes a plurality of multiplexed signals, and the first signal includes a plurality of first signals, each of the multiplexed signals including a corresponding one of the first signals, the method further including causing the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 24 includes the subject matter of Example 22, and, optionally, wherein there exist three nulls between each pair of non-zero real or complex tones of the first signal in the frequency domain.

Example 25 includes the subject matter of Example 22, and optionally, wherein: the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256; the second signal has guard bands of 0.8, 1.6, or 3.2 μsec; and the smallest RUs include 26 tones.

Example 26 includes the subject matter of any one of Examples 22-25, wand optionally, herein a modulation of the first signal is On-Off Keying (OOK).

Example 27 includes the subject matter of any one of Examples 22-25, wand optionally, herein: the first signal is contained within a central RU of the second signal; and the RUs adjacent the central RU are unassigned.

Example 28 includes the subject matter of any one of Examples 22-25, and optionally, wherein the second signal further carries information indicating an identifier for the wireless device.

Example 29 includes the subject matter of any one of Examples 22-25 and optionally, further comprising: a radio; and a front-end module coupled to the radio.

Example 30 includes the subject matter of Example 29, and, optionally, further including one or more antennas connected to the front-end module.

Example 31 include a wireless communication device, the device comprising: means for causing a low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”; and means for causing a wake-up of the main baseband processor based on the first signal; and means for causing the main baseband processor to process subsequent OFDMA signals after waking up.

Example 32 includes the subject matter of Example 31, and optionally, wherein the multiplexed signal includes a plurality of multiplexed signals, and the first signal includes a plurality of first signals, each of the multiplexed signals including a corresponding one of the first signals, the device further including means for causing the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 33 includes the subject matter of Example 31, and, optionally, wherein there exist three nulls between each pair of non-zero real or complex tones of the first signal in the frequency domain.

Example 34 includes the subject matter of any one of Examples 31-33, and optionally, wherein: the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256; the second signal has guard bands of 0.8, 1.6, or 3.2 μsec; and the smallest RUs include 26 tones.

Example 35 includes a wireless communication device comprising a memory and processing circuitry coupled to the memory, the processing circuitry including logic to: multiplex a first signal into a second signal; encode the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and cause transmission of a multiplexed signal including the second signal and the first signal multiplexed into the second signal.

Example 36 includes the subject matter of Example 35, and optionally, wherein the multiplexed signal includes a plurality of multiplexed signals, and the first signal includes a plurality of first signals, each of the multiplexed signals including a corresponding one of the first signals, the logic further to cause transmission of a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 37 includes the subject matter of Example 35, and optionally, wherein there exist three nulls between each pair of non-zero real or complex tones of the first signal in the frequency domain.

Example 38 includes the subject matter of Example 35, and, optionally, wherein: the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256.

Example 39 includes the subject matter of Example 35, and optionally, wherein the smallest RUs include 26 tones.

Example 40 includes the subject matter of any one of Examples 35-39, and, optionally, wherein a modulation of the first signal is On-Off Keying (OOK).

Example 41 includes the subject matter of any one of Examples 35-39 and optionally, wherein the multiplexed signal has a contiguous bandwidth of 20 MHz, 40 MHz, 80 MHz, 160 MHz, or 320 MHz, or a non-contiguous bandwidth of 80+80 MHz (160 MHz).

Example 42 includes the subject matter of any one of Examples 35-39, and optionally, wherein the logic is to generate, for the multiplexed signal, a legacy short-training field (L-STF), a legacy long training field (L-LTF), and a legacy signal (L-SIG) field to precede the second signal in the time domain, and wherein the L-STF, L-LTF, and L-SIG are to be transmitted on a full bandwidth of the signal.

Example 43 includes the subject matter of any one of Examples 35-39 and optionally, wherein the first signal is contained within a central RU of the second signal.

Example 44 includes the subject matter of any one of Examples 35-39 and optionally, wherein one or more RUs adjacent the one RU of the plurality of smallest RUs are unassigned.

Example 45 includes the subject matter of any one of Examples 35-39 and optionally, wherein the second signal further carries information indicating an identifier for another wireless device to process the second signal.

Example 46 includes the subject matter of any one of Examples 35-39 and optionally, wherein: the first signal is in conformance with an IEEE Low-Power Wake-Up Receiver wireless communication protocol; and the second signal is in conformance with an Institute of Electrical and Electronics Engineers (IEEE) 802.11ax wireless communication protocol.

Example 47 includes the subject matter of any one of Examples 35-39 and optionally, further comprising: a radio; a front-end module coupled to the radio; a baseband processor coupled to the radio and to the front-end module, the baseband processor to generate the multiplexed signal.

Example 48 includes the subject matter of Example 47, and, optionally, further including one or more antennas connected to the first front-end module and the second front-end module to communicate the multiplexed signal.

Example 49 includes a method to be performed by a wireless communication device, the method comprising: multiplexing a first signal into a second signal; encoding the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and causing transmission of a multiplexed signal including the second signal and the first signal multiplexed into the second signal.

Example 50 includes the subject matter of Example 49, and optionally, wherein the multiplexed signal includes a plurality of multiplexed signals, and the first signal includes a plurality of first signals, each of the multiplexed signals including a corresponding one of the first signals, the method further including causing transmission of a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 51 includes the subject matter of Example 49, and, optionally, wherein there exist three nulls between each pair of non-zero real or complex tones of the first signal in the frequency domain.

Example 52 includes the subject matter of Example 49, and, optionally, wherein: the first signal has a bandwidth of at least 2.031 MHz; the second signal has a bandwidth of 20 MHz; the tone spacing is 78.125 kHz; the symbol duration is 12.8p; and the first signal and the second signal both have a FFT size of 256.

Example 53 includes the subject matter of any one of Examples 49-52, and optionally, wherein the smallest RUs include 26 tones.

Example 54 includes the subject matter of any one of Examples 49-52, and optionally, wherein a modulation of the first signal is On-Off Keying (OOK).

Example 55 includes the subject matter of any one of Examples 49-52, wand optionally, herein the multiplexed signal has a contiguous bandwidth of 20 MHz, 40 MHz, 80 MHz, 160 MHz, or 320 MHz, or a non-contiguous bandwidth of 80+80 MHz (160 MHz).

Example 56 includes the subject matter of any one of Examples 49-52, and optionally, wherein the logic is to generate, for the multiplexed signal, a legacy short-training field (L-STF), a legacy long training field (L-LTF), and a legacy signal (L-SIG) field to precede the second signal in the time domain, and wherein the L-STF, L-LTF, and L-SIG are to be transmitted on a full bandwidth of the multiplexed signal.

Example 57 includes the subject matter of any one of Examples 49-52, and optionally, wherein the first signal is contained within a central RU of the second signal.

Example 58 includes the subject matter of any one of Examples 49-52, and optionally, wherein one or more RUs adjacent the one RU of the plurality of smallest RUs are unassigned.

Example 59 includes the subject matter of any one of Examples 49-52, and optionally, wherein the second signal further carries information indicating an identifier for another wireless device to process the second signal.

Example 60 includes a product comprising one or more tangible computer-readable non-transitory storage media comprising computer-executable instructions operable to, when executed by at least one computer processor, enable the at least one computer processor to implement operations at a wireless communication device, the operations comprising: multiplexing a first signal into a second signal; encoding the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and causing transmission of a multiplexed signal including the second signal and the first signal multiplexed into the second signal.

Example 61 includes the subject matter of Example 60, and optionally, wherein the multiplexed signal includes a plurality of multiplexed signals, and the first signal includes a plurality of first signals, each of the multiplexed signals including a corresponding one of the first signals, the operations further comprising causing transmission of a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 62 includes the subject matter of Example 60, and optionally, wherein there exist three nulls between each pair of non-zero real or complex tones of the first signal in the frequency domain.

Example 63 includes the subject matter of Example 60, and optionally, wherein: the first signal has a bandwidth of at least 2.031 MHz; the second signal has a bandwidth of 20 MHz; the tone spacing is 78.125 kHz; the symbol duration is 12.8p; the first signal and the second signal both have a FFT size of 256. **

Example 64 includes the subject matter of any one of Examples 60-63, and optionally, wherein the smallest RUs include 26 tones.

Example 65 includes the subject matter of any one of Examples 60-63, and optionally, wherein a modulation of the first signal is On-Off Keying (OOK).

Example 66 includes the subject matter of any one of Examples 60-63, and optionally, wherein the multiplexed signal has a contiguous bandwidth of 20 MHz, 40 MHz, 80 MHz, 160 MHz, or 320 MHz, or a non-contiguous bandwidth of 80+80 MHz (160 MHz).

Example 67 includes the subject matter of any one of Examples 60-63, and optionally, wherein the first signal is contained within a central RU of the second signal.

Example 68 includes the subject matter of any one of Examples 60-63, and optionally, wherein one or more RUs adjacent the one RU of the plurality of smallest RUs are unassigned.

Example 69 includes a wireless communication device comprising: means for multiplexing a first signal into a second signal; means for encoding the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and means for causing transmission of a multiplexed signal including the second signal and the first signal multiplexed into the second signal.

Example 70 includes the subject matter of Example 69, and optionally, wherein the multiplexed signal includes a plurality of multiplexed signals, and the first signal includes a plurality of first signals, each of the multiplexed signals including a corresponding one of the first signals, the device further including means for causing transmission of a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

Example 71 includes the subject matter of Example 69, and, optionally, wherein the smallest RUs include 26 tones.

Example 72 includes the subject matter of any one of Examples 69-71, and optionally, wherein a modulation of the first signal is On-Off Keying (OOK).

Example 73 includes the subject matter of any one of Examples 69-71 and optionally, wherein the first signal is contained within a central RU of the second signal.

Example 74 includes the subject matter of any one of Examples 69-71 and optionally, wherein one or more RUs adjacent the one RU of the plurality of smallest RUs are unassigned.

An Abstract is provided. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device comprising a memory and processing circuitry coupled to the memory, the processing circuitry including a main baseband processor and a low power baseband processor, the processing circuitry further including logic to:
cause the low-power baseband processor to process a first signal in a multiplexed signal, the multiplexed signal including the first signal multiplexed into a second signal, wherein the first signal and the second signal use orthogonal frequency divisional multiple access (OFDMA), the first signal being contained within one of a plurality of smallest resource units (RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and
cause a wake-up of the main baseband processor based on the first signal; and
cause the main baseband processor to process subsequent OFDMA signals after waking up.

2. The wireless device of claim 1, wherein the multiplexed signal includes a plurality of multiplexed signals, and the first signal includes a plurality of first signals, each of the multiplexed signals including a corresponding one of the first signals, the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

3. The wireless device of claim 1, wherein each pair of non-zero real or complex tones of the first signal in the frequency domain include three nulls therebetween.

4. The wireless device of claim 1, wherein:
the first signal has a bandwidth of at least 2.031 MHz;
the second signal has a bandwidth of 20 MHz;
the tone spacing is 78.125 kHz;
the symbol duration is 12.8 μs;
the first signal and the second signal both have a FFT size of 256;
the second signal has guard bands of 0.8, 1.6, or 3.2 μsec; and
the smallest RUs include 26 tones.

5. The wireless device of claim 1, wherein a modulation of the first signal is On-Off Keying (OOK).

6. The wireless device of claim 1, wherein the first signal is contained within a central RU of the second signal.

7. The wireless device of claim 1, wherein one or more RUs adjacent the one RU of the plurality of smallest RUs are unassigned.

8. The wireless device of claim 1, further comprising:
a radio; and
a front-end module coupled to the radio.

9. The wireless device of claim 8, further including one or more antennas connected to the front-end module.

10. A product comprising one or more tangible computer-readable non-transitory storage media comprising computer-executable instructions operable to, when executed by at least one computer processor, enable the at least one computer processor to implement operations at a wireless communication device, the operations comprising:
cause a low-power baseband processor to process a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”; and
causing a wake-up of a main baseband processor based on the first signal; and
causing the main baseband processor to process subsequent OFDMA signals after waking up.

11. The product of claim 10, wherein the multiplexed signal includes a plurality of multiplexed signals, and the first signal includes a plurality of first signals, each of the multiplexed signals including a corresponding one of the first signals, the logic to cause the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

12. The product of claim 10, wherein each pair of non-zero real or complex tones of the first signal in the frequency domain include three nulls therebetween.

13. The product of claim 10, wherein:
the first signal is contained within a central RU of the second signal; and
the RUs adjacent the central RU are unassigned.

14. A wireless communication device, the device comprising:
means for processing a first signal in a multiplexed signal, the multiplexed signal including the first signal multiplexed into a second signal, wherein the first signal and the second signal use orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal presenting a sequence including a number of repeated portions in a time domain and a number of nulls in a frequency domain, the nulls being between non-zero tones, the sequence representing an information bit of “1”; and
means for causing a wake-up of the main baseband processor based on the first signal; and
means for causing the main baseband processor to process subsequent OFDMA signals after waking up.

15. The wireless device of claim 14, wherein the multiplexed signal includes a plurality of multiplexed signals, and the first signal includes a plurality of first signals, each of the multiplexed signals including a corresponding one of the first signals, the device further including means for causing the low-power baseband processor to process a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

16. The wireless device of claim 14, wherein each pair of non-zero real or complex tones of the first signal in the frequency domain include three nulls therebetween.

17. The wireless device of claim 14, wherein:
the first signal is contained within a central RU of the second signal; and
the RUs adjacent the central RU are unassigned.

18. The wireless device of claim 14, wherein the second signal further carries information indicating an identifier for the wireless device.

19. A wireless communication device comprising a memory and processing circuitry coupled to the memory, the processing circuitry including logic to:
multiplex a first signal into a second signal;
encode the first signal and second signal using orthogonal frequency divisional multiple access (OFDMA), a the first signal being contained within one of a plurality of smallest resource units (smallest RUs) of the second signal, the first signal and the second signal having a same number of tones and a same tone spacing in a frequency domain, and a same symbol duration in a time domain, the first signal including a number of repeated portions in a time domain and a number of nulls in a frequency domain and representing an information bit of “1”; and
cause transmission of a multiplexed signal including the second signal and the first signal multiplexed into the second signal.

20. The wireless device of claim 19, wherein the multiplexed signal includes a plurality of multiplexed signals, and the first signal includes a plurality of first signals, each of the multiplexed signals including a corresponding one of the first signals, the logic further to cause transmission of a sequence of OFDMA signals including the multiplexed signals interspersed with silence periods, the sequence of OFDMA signals representing a low-power wake-up (LP-WU) packet where the first signals represent an information bit of “1” and where the silence periods represent an information bit of “0”.

21. The wireless device of claim 19, wherein each pair of non-zero real or complex tones of the first signal in the frequency domain include three nulls therebetween.

22. The wireless device of claim 19, wherein:
the first signal has a bandwidth of at least 2.031 MHz;
the second signal has a bandwidth of 20 MHz;
the tone spacing is 78.125 kHz;
the symbol duration is 12.8 μs.
the first signal and the second signal both have a FFT size of 256.

23. The wireless device of claim 19, wherein a modulation of the first signal is On-Off Keying (OOK).

24. The wireless device of claim 19, wherein the first signal is contained within a central RU of the second signal, and wherein one or more RUs adjacent the one RU of the plurality of smallest RUs are unassigned.

25. The wireless device of claim 19, further comprising:
a radio;
front-end module coupled to the radio;
a baseband processor coupled to the radio and to the front-end module, the baseband processor to generate the signal.
